(19) United States
(12) Patent Application Publication
(10) Pub. No.: US 2018/0353051 A1
(43) Pub. Date: Dec. 13, 2018

(54) Stair Cleaning Device and Method

(71) Applicant: Debra Clark, Stevenson Ranch, CA (US)

(72) Inventor: Debra Clark, Stevenson Ranch, CA (US)

(21) Appl. No.: 15/997,060

(22) Filed: Jun. 4, 2018

Related U.S. Application Data
(60) Provisional application No. 62/518,928, filed on Jun. 13, 2017.

(51) Int. Cl. A47L 25/00; B08B 7/00

(52) U.S. Cl. CPC A47L 25/005; B08B 7/0028

(57) ABSTRACT

A surface cleaning device and method of use are provided. The surface cleaning device includes a strip of flexible material having an adhesive on one surface that can removably secure the strip to a strip cover before use, or a surface or surface crease during use. The strip may be included with one or more additional strips, forming a sheet, wherein a plurality of sets of horizontal perforations is disposed along the length of the sheet such that the strip can be removed from the sheet by tearing along the perforations. Once the strip is removed from the sheet and the cover, the strip adhesive may be applied to a surface or a surface crease, such as a stair or a stair crease, to enable the adhesive to attach to, and thereby easily remove dirt, dust, hair, debris, and the like, from the surface or surface crease.

### CROSS REFERENCE TO RELATED APPLICATIONS

This application claims priority under 35 U.S.C. § 119(e) to U.S. Provisional Application No. 62/518,928 filed on Jun. 13, 2017. The above identified patent application is incorporated by reference herein in its entirety to provide continuity of disclosure.

### BACKGROUND OF THE INVENTION

Surfaces such as stairs accumulate dirt, dust, hair, and debris during ordinary use, and require cleaning periodically. Existing solutions for cleaning surfaces such as stairs, particularly the creases between the risers (vertical portions) and the treads (horizontal portions) of a staircase, may not be easy for many individuals. Vacuum cleaners, including modern and historical designs, may be heavy, difficult, and even dangerous when maneuvering on stairs.

Therefore, there is a need in the art for an improved, lightweight device and related method of use for cleaning surfaces with creases, such as stairs. The present invention addresses this unmet need.

### FIELD OF THE INVENTION

The present invention relates to a device and method for cleaning surfaces with creases, such as stairs.

Devices have been disclosed in the art that relate to cleaning surfaces such as stairs. These include devices that have been patented and published in patent application publications. These devices are often heavy or difficult to use safely. In view of the devices disclosed in the art, it is submitted that there is a need in the art for an improvement to existing surface cleaning devices. In view of the present disclosure, it is submitted that the present invention substantially diverges in structural and functional elements from devices and methods in the art, and the instant invention substantially fulfills an unmet need in the art.

### SUMMARY OF THE INVENTION

In view of the disadvantages inherent in the known types of surface cleaning solutions in the art, the present invention provides a new and improved device and method, wherein the same can be utilized for providing convenience and safety to a user when cleaning surfaces such as stairs.

It is therefore an object of the present invention to provide a surface cleaning device for cleaning surfaces with creases, such as stairs.

It is another object of the present invention to provide a method for cleaning surfaces with creases, such as stairs that utilizes the device.

Another object of the present invention is to provide a convenient method for cleaning surfaces with creases, such as stairs.

Yet another object of the present invention is to provide a safe method for cleaning surfaces with creases, such as stairs.

Another object of the present invention is to provide a surface cleaning device that may be readily manufactured from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of the invention will be particularly pointed out in the claims, the invention itself and manners in which it may be made and used may be better understood after a review of the following description, taken in connection with the accompanying drawings, wherein like numeral annotations are provided throughout.

FIG. 1 depicts a perspective view of an embodiment of a surface cleaning strip in use with a stair case.

FIG. 2 depicts a perspective view of an embodiment of a surface cleaning strip applied to a stair crease.

FIG. 3 depicts a perspective view of an embodiment of a surface cleaning strip after being applied to a stair crease.

FIG. 4 depicts a perspective view of an embodiment of a sheet of surface cleaning strips having horizontal perforations between the surface cleaning strips.

FIG. 5 depicts a perspective view of an embodiment of a sheet of surface cleaning strips having horizontal perforations between the surface cleaning strips, wherein a surface cleaning strip is being removed from the sheet of surface cleaning strips, and wherein a cover of the surface cleaning strip is being removed from an adhesive of the surface cleaning strip.

### DETAILED DESCRIPTION OF THE INVENTION

Reference is made herein to the attached drawings. Like reference numerals are used throughout the drawings to depict like or similar elements of the surface cleaning device. The figures are intended for representative purposes only and should not be considered to be limiting in any respect.

In one aspect, the invention provides a device in the form of a strip having an adhesive attached to one side thereon. Before use, the adhesive is removably attached to a strip cover, and the strip may be removably attached to one or more additional strips, forming a sheet. To use the device, the strip may be removed from the sheet by tearing along horizontal perforations in the sheet which effectively link together the strips before they are needed for use. To use the device, the strip cover may be removed from the adhesive on the strip, thereby exposing the adhesive and preparing the strip for use.

Generally, the invention provides a method of cleaning a portion of a surface with a crease, such as a stair, comprising: contacting the portion of the surface with an adhesive, adhering the adhesive to the portion of the surface, and removing the adhesive from the portion of the surface. The invention provides a generic surface and crease cleaning device and method. In various embodiments, the method may be repeated until all or a part of the surface is clean or substantially clear of dirt, dust, hair, or debris.

The invention also provides a method of cleaning a portion of a surface, consisting essentially of: contacting the portion of the surface with an adhesive, adhering the adhesive to the portion of the surface, and removing the adhesive from the portion of the surface.

The invention also provides a method of cleaning a portion of a surface, consisting of: contacting the portion of the surface with an adhesive, adhering the adhesive to the portion of the surface, and removing the adhesive from the portion of the surface.

In various embodiments of the invention, the adhesive is secured to a first side of a strip and the strip comprises a first end and a second end and is configured to rest flush against the portion of the surface; the strip is removed from a sheet of strips having perforations therebetween; a strip cover is removed from the strip, thereby exposing the adhesive; the strip is flexible; the adhesive is adhered to the portion of the surface by applying a force to a second side of the strip; a width of the portion of the surface is about equal to a width of the surface; a length of the strip is adjusted by tearing the strip along a set of perforations in the strip, such that the length of the strip is about equal to the width of the portion of the surface; the portion of the surface comprises at least one surface selected from the group including, but not necessarily limited to: a stair tread surface, a stair corner surface, a stair riser surface, a stair crease surface, and a combination thereof; and/or before cleaning, the portion of the surface comprises at least one substance selected from the group including, but not necessarily limited to: a dirt, a dust, a hair, a debris, and a combination thereof.

Reference is now made to the drawings, which depict one or more exemplary embodiments of the invention.

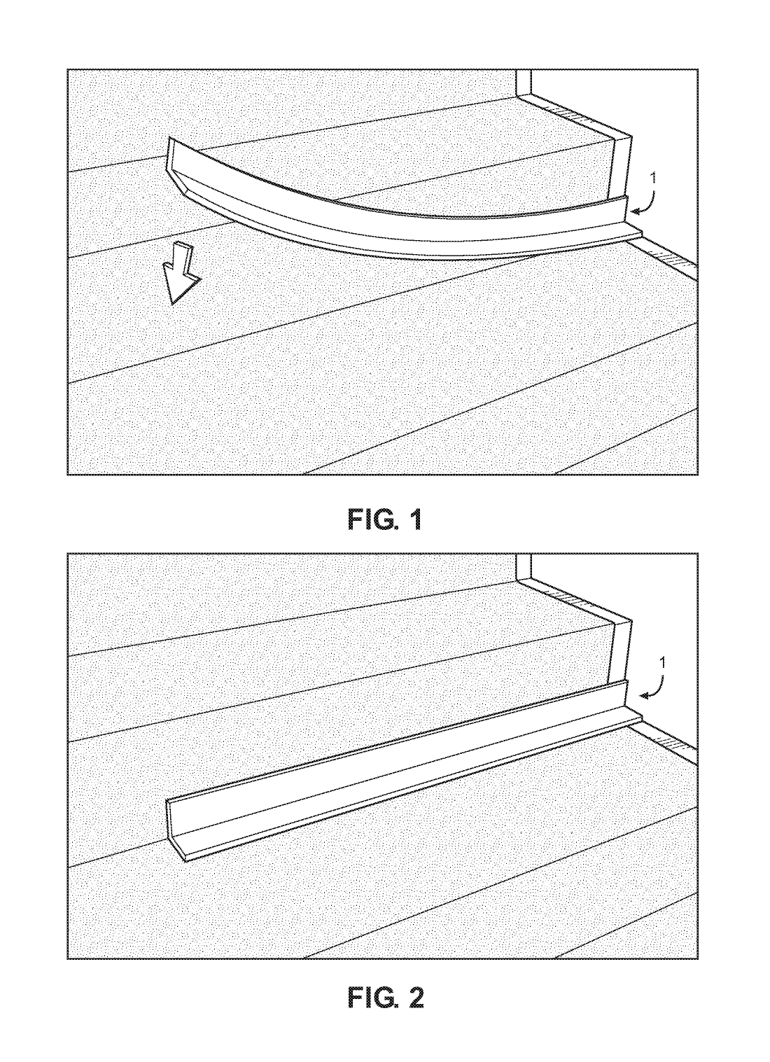

Referring now to FIG. 1, there is depicted a perspective view of an embodiment of a surface cleaning strip in use with a stair case. In the embodiment depicted, the strip 1 is first gently applied to one end of a stair crease, then a force is applied to adhere the adhesive to the stair crease. Thereafter, a force is applied down the length of the strip, either by continuously applying the force along a continuum of positions along the strip, or by intermittently applying the force along a finite number of positions along the strip, until the strip 1 is substantially adhered to the stair crease.

Referring now to FIG. 2, there is depicted a perspective view of an embodiment of a surface cleaning strip applied to a stair crease. In the embodiment depicted, the strip 1 is substantially adhered to the stair crease. The strip is applied to a stair crease such that an upper portion and lower portion of the strip are formed perpendicular to each other about a middle portion, such that the lower portion is adhered to the tread and the upper portion is adhered to the riser, and the middle portion is adhered or substantially adhered to the stair crease.

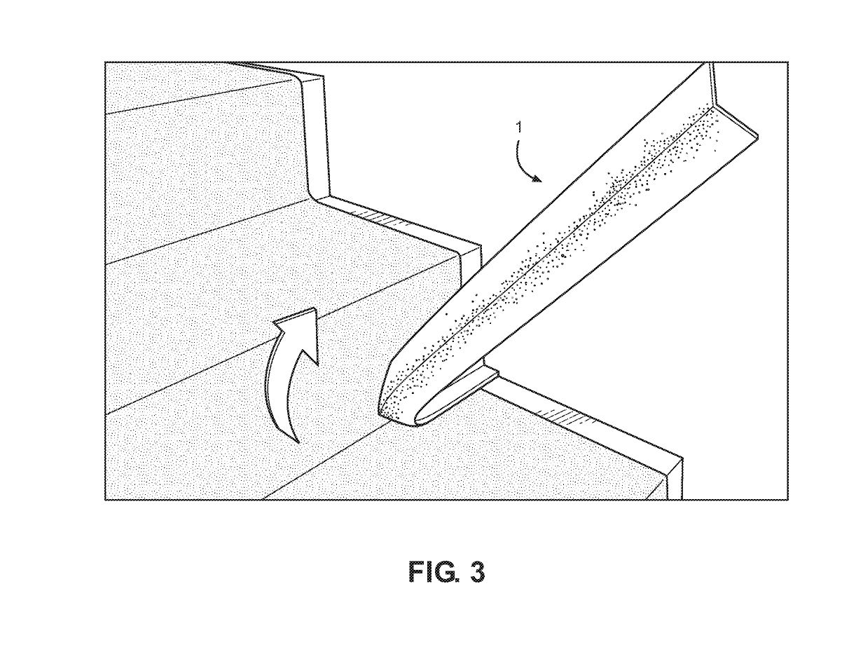

Referring now to FIG. 3, there is depicted a perspective view of an embodiment of a surface cleaning strip after being applied to a stair crease. In the embodiment depicted, the strip 1 is being removed from the stair crease, causing the adhesive to remove dirt, dust, hair, or debris that was previously on the stair crease.

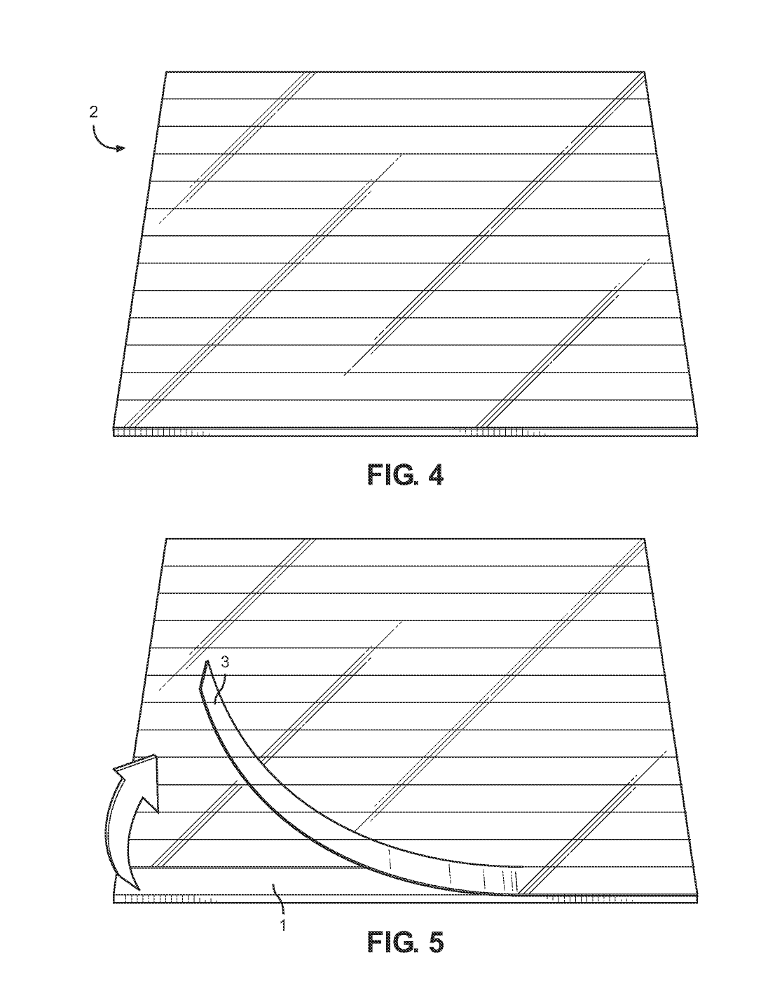

Referring now to FIG. 4, there is depicted a perspective view of an embodiment of a sheet of surface cleaning strips having horizontal perforations between the surface cleaning strips. In the embodiment depicted, the sheet of surface cleaning strips 2 includes thirteen surface cleaning strips, wherein the strips are separated by horizontal perforations, depicted in FIG. 4 as horizontal lines. The benefits of having the strips connected before use include ease of manufacturing, ease of delivery to the user, and cost-effectiveness. In alternate embodiments, the strips include a plurality of sets of vertical perforations that may be used to adjust the length of one or more strips before use. The benefits of the strips being easily adjustable by length include easier application to a stair, covering a wider or a narrower portion of the stair as necessary, and conforming the length of the strip to a length of a portion of a stair.

Referring now to FIG. 5, there is depicted a perspective view of an embodiment of a sheet of surface cleaning strips having horizontal perforations between the surface cleaning strips, wherein a cover of the surface cleaning strip is being removed from an adhesive of the surface cleaning strip. In the embodiment depicted, a strip cover 3 is being removed from the strip 1, and the strip 1 is about to be removed from the sheet of surface cleaning strips. When applied to the adhesive, the strip cover 3 protects the adhesive from dirt, dust, and debris when the adhesive is not in use.

The foregoing descriptions of specific embodiments of the present invention have been presented for purposes of illustration and description. They are not intended to be exhaustive or to limit the present invention to the precise forms disclosed, and modifications and variations are possible in view of the above teaching. The exemplary embodiment was chosen and described to best explain the principles of the present invention and its practical application, to thereby enable others skilled in the art to best utilize the present invention and its embodiments with modifications as suited to the use contemplated.

It is therefore submitted that the instant invention has been shown and described in the most practical and exemplary embodiments. It should be recognized that departures may be made which fall within the scope of the invention. With respect to the description provided herein, it is submitted that the optimal features of the invention include variations in size, materials, shape, form, function and manner of operation, assembly, and use. All structures, functions, and relationships equivalent or essentially equivalent to those disclosed are intended to be encompassed by the present invention.

I claim:

1) A method of cleaning a portion of a surface, comprising:
a) contacting the portion of the surface with an adhesive,
b) adhering the adhesive to the portion of the surface,
c) removing the adhesive from the portion of the surface.

2) The method of claim 1, wherein the adhesive is secured to a first side of a strip, wherein the strip comprises a first end and a second end and is configured to rest flush against the portion of the surface.

3) The method of claim 2, comprising removing the strip from a sheet of strips having perforations therebetween.

4) The method of claim 3, comprising removing a strip cover from the strip, thereby exposing the adhesive.

5) The method of claim 2, wherein the strip is flexible.

6) The method of claim 5, wherein adhering the adhesive to the portion of the surface comprises applying a force to a second side of the strip.

7) The method of claim 6, wherein a width of the portion of the surface is about equal to a width of the surface.

8) The method of claim 7, wherein a length of the strip is adjusted by tearing the strip along a set of perforations in the strip, such that the length of the strip is about equal to the width of the portion of the surface.

9) The method of claim 8, wherein the portion of the surface comprises at least one surface selected from the group consisting of: a stair tread surface, a stair corner surface, a stair riser surface, a stair crease surface, and a combination thereof.

10) The method of claim 9, wherein before cleaning, the portion of the surface comprises at least one substance selected from the group consisting of: a dirt, a dust, a hair, a debris, and a combination thereof.

11) A method of cleaning a portion of a surface, consisting essentially of:
a) contacting the portion of the surface with an adhesive,
b) adhering the adhesive to the portion of the surface,
c) removing the adhesive from the portion of the surface.

12) The method of claim 11, wherein the adhesive is secured to a first side of a strip, wherein the strip comprises a first end and a second end and is configured to rest flush against the portion of the surface.

13) The method of claim 12, comprising removing the strip from a sheet of strips having perforations therebetween.

14) The method of claim 13, comprising removing a strip cover from the strip, thereby exposing the adhesive.

15) The method of claim 12, wherein the strip is flexible.

16) The method of claim 15, wherein adhering the adhesive to the portion of the surface comprises applying a force to a second side of the strip.

17) The method of claim 16, wherein a width of the portion of the surface is about equal to a width of the surface.

18) The method of claim 17, wherein a length of the strip is adjusted by tearing the strip along a set of perforations in the strip, such that the length of the strip is about equal to the width of the portion of the surface.

19) The method of claim 18, wherein the portion of the surface comprises at least one surface selected from the group consisting of: a stair tread surface, a stair corner surface, a stair riser surface, a stair crease surface, and a combination thereof.

20) The method of claim 19, wherein before cleaning, the portion of the surface comprises at least one substance selected from the group consisting of: a dirt, a dust, a hair, a debris, and a combination thereof.
